(19) United States
(12) Patent Application Publication
(10) Pub. No.: US 2011/0320486 A1
(43) Pub. Date: Dec. 29, 2011

(54) SYSTEM AND METHOD FOR ENABLING MATCHING OF EXHIBITION PARTICIPANTS

(75) Inventors: Shlomo Berkovitch, Ra'anana (IL); Motti Kleinmann, Hod Hasharon (IL); David Margalit, Modi'in (IL)

(73) Assignee: EXPOBEE LTD., Hod Hasharon (IL)

(21) Appl. No.: 13/254,247

(22) PCT Filed: Mar. 1, 2010
(86) PCT No.: PCT/IB10/50874

§ 371 Date: Sep. 1, 2011

Related U.S. Application Data
(60) Provisional application No. 61/156,514, filed on Mar. 1, 2009.

(51) Int. Cl. G06F 17/30

(52) U.S. Cl. 707/769; 707/E17.014

(57) ABSTRACT

There is provided, in accordance with an embodiment of the present invention, an apparatus, system, and method for enabling automated participant matching at an exhibition. According to some embodiments of the present invention, the system may include multiple scan-able labels for multiple objects in an exhibition; scanning devices adapted to scan data from the labels; a communications server for enabling collection and communication of the scanned data, the communications server being coupled to an exhibition server being in communication with a system database; and a matching server adapted to generate matches between exhibition participants.

### CROSS REFERENCE TO RELATED APPLICATIONS

This application claims the benefit of U.S. Provisional Patent Application No. 61/156,514, filed Mar. 1, 2009, entitled “SYSTEM AND METHOD FOR ENABLING AUTOMATED MATCHING OF POTENTIAL SELLERS AND BUYERS”, which is incorporated in its entirety herein by reference.

### FIELD OF THE INVENTION

The present invention relates to systems and methods for handling exhibition or consumer show management. Specifically, embodiments of the present invention relate to systems, methods and apparatuses that enable automated matching between exhibition participants.

### BACKGROUND OF THE INVENTION

Exhibitions, consumer shows, conferences and the like bring together hundreds or thousands of people with similar interests. Typically, the vendors or products or information show off their wears to interested visitors, enabling interaction between such vendors and visitors.

More recently, various systems and methods have been developed to help manage such exhibitions or shows, thereby enabling a higher degree of vendor and visitor data utilization and even user behavior tracking. However, the fundamental meeting of vendors and visitors, typically at a sales booth, remains a personal challenge for both parties. Further, even though a vendor may make great efforts to initiate meetings with potential customers or interested parties, it is common that most visitors are not actually relevant potential customers, leading to significant wastage in resources.

It would be highly advantageous to have a system that enables smart matching of participants, thereby allowing greater efficiency in meeting initiation and commercial matching.

### SUMMARY OF THE INVENTION

There is provided, in accordance with an embodiment of the present invention, an apparatus, system, and method for enabling automated participant matching at an exhibition. According to some embodiments of the present invention, the system may include multiple scan-able labels for multiple objects in an exhibition; scanning devices adapted to scan data from the labels; a communications server for enabling collection and communication of the scanned data, the communications server being coupled to an exhibition server being in communication with a system database; and a matching server adapted to generate matches between exhibition participants.

In some embodiments the matching server is adapted to deliver matching alerts to selected exhibition participants.

In further embodiments the matching server includes business logic for enabling automated matching of participants, based on data from the system database. In other embodiments the matching server includes business logic for managing matching the data of the participants.

In yet other embodiments the matching server is capable to implement one or more processing actions, such as collecting, tracking, analyzing, enriching and filtering data from the system database. In some embodiments the matching server is capable to generate real time data and/or alerts relating to matched participants.

In further embodiments the matching server is capable to determine a match between a first participant and a second participant, and to send an alert to the first participant when the first participant comes within a selected proximity of the second participant. In some embodiments the matching of a first participants needs with a second participants products may be based on the first participant's profile, behavior and/or scanning activity.

According to some embodiments of the present invention, a method for enabling automated participant matching at an exhibition is provided, including: registering in the exhibition's system database each object to be displayed, in conjunction with an exhibitor's relevant information; defining matching rules for each label; generating a label for each object that is to be presented by an exhibitor; attaching a label to each object being presented; registering a participant with exhibition's system database, and entering relevant participant data and giving the participant a scanning device associated with the participant's user data; and generating a match between an exhibitor and a participant.

In some embodiments an alert may be transmitted to the exhibitor and/or the participant. In some embodiments alerts may be sent as SMS, MMS, Instant Message, Email, and/or a message using other messaging means. In other embodiments multiple records of matching data may be managed for exhibition participants.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram of an exhibition management system, according to some embodiments;

FIG. 2 is a schematic block diagram of a system enabling automated buyer and seller matching, according to some embodiments; and

FIG. 3 is a flowchart illustrating a process of automated buyer and seller matching, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details.

The word “exhibition” as used herein may encompass fairs, trade shows, conferences, conventions, markets, shopping centers, events or other gatherings of prospective buyers and sellers, service providers, consumers etc. The word “exhibitor” as used herein may encompass traders, organizations, companies, governmental entities, sellers, service providers, vendors, publicizers, booths, stalls etc. The word “participants” as used herein may encompass vendors, suppliers, sellers, investors, agents, visitors, buyers, consumers, presenters etc. The word “consumers” as used herein may encompass actual or potential associates, buyers, clients, visitors, traders or other interested parties. The word “buyers” may encompass consumers, visitors, potential partners, associates, clients, customers and other interested parties. The word “sellers” may encompass service providers, exhibitors, vendors, sales personnel and other parties involved in promotions, sales, marketing, and business development. The word “objects” may encompass products, advertisements, booths, materials, literature, salespeople, vendors, items or other objects of interest in an exhibition.

Embodiments of the present invention enable automated matching of potential sellers and buyers, for example, at an exhibition, fair, trade show or convention. In some embodiments such automated matching may be adapted to match between preferred or specifically defined potential partners or clients. In further embodiments a method for real time identification of preferred visitors is provided, such that, for example, the exhibitors can identify potential clients or partners while they are visiting at the exhibitor's booth or site.

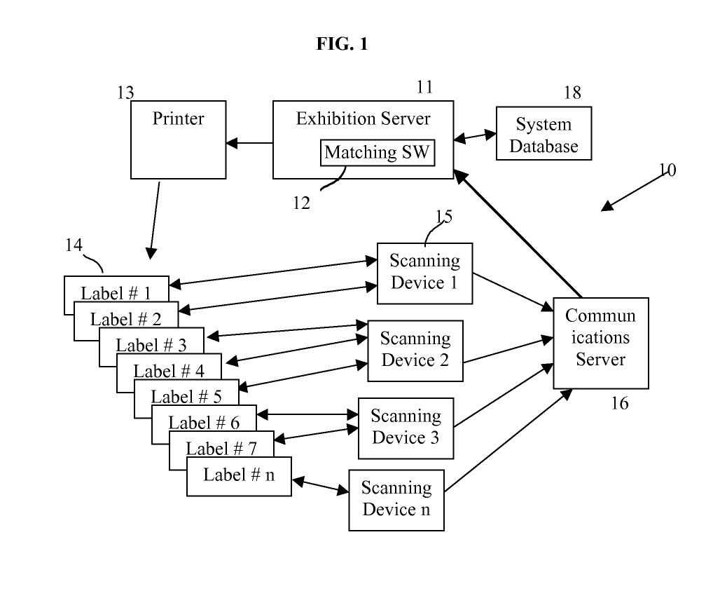

Reference is now made to FIG. 1 which is a schematic block diagram illustration of a system for enabling exhibition show management automated matching of participants, such as potential sellers and buyers, according to some embodiments. As can be seen in FIG. 1, the system 10 may include an exhibition server 11 running matching software 12, and a printer 13, connected to exhibition server 11, for printing out scan-able labels 14 for multiple objects, such as products, booths or people. The matching software 12 may include or be coupled to a system database 18, which may store, for example, system data, object data, exhibitor data, label data, visitor data, communications data etc. The system may further include multiple handheld or worn devices, such as badges or scanning devices 15 with integrated scanners for scanning or reading labels 14, for example, barcode readers, 2D barcode readers, RFID readers, Bluetooth, Zigbee etc. The handheld devices 15 are connected wirelessly to exhibition server 11, for example using a Radio Network, which may incorporate Wi-Fi, ZigBee, cellular technology, Bluetooth, satellite or any other proprietary or publically available wireless communications technology. Data may be transmitted to exhibition server 11 via a communications server 16, which may collect, aggregate, filter and/or process the data prior to being transmitted to exhibition server 11.

According to some embodiments, an exhibitor may register all relevant objects, products, promotions, materials or people etc. that they would like to introduce in an exhibition into the server, optionally via a remote or connected terminal or computing device. Each object registered will be identified according to the unique exhibitor ID. The server will generate data for product tags or labels that will be attached to the displayed objects or materials etc., or to a catalog or other materials showing the object details. Each label will be configured to contain a unique ID of the object, and optionally other relevant data. The server will send the relevant label data to the system printer, which will print out scan-able labels for each relevant product or object etc. The exhibitor will attached or couple a label to all relevant products or objects etc. In some embodiments the labels will transmit data, for example, via Rf, Wi-Fi, Bluetooth, Zigbee or other wireless transmission means. Consumers, visitors or buyers may initially register themselves with the system, optionally via a remote or connected terminal or computing device. The consumers may enter into the system relevant data about themselves and/or their preferences. The consumers will be given wireless scanning devices that are enabled to maintain user registered data and to scan labels, and optionally update user registration data. When a consumer sees a product, person or item of interest, the user may use their wireless scanning device to scan the relevant label(s), whereby the wireless device will record all relevant labels. The scanning devices may include a display (e.g., for displaying scanned data, messages, alerts or other suitable data, and optionally user registration data). The scanning devices may include a buzzer, LED, or other suitable alerting mechanism (for alerting the user to potential labels of interest or when matches are made. For example, the scanning devices may send the scanned data to the server via the wireless link. The server will do the matching check, and in the case of a match, will send an alert or message to the relevant scanning device and/or exhibitor terminal/device.

The scanning devices may include a scanner mechanism for enabling RfID scanning, barcode scanning, infrared scanning, or other suitable scanning mechanisms or technologies. The data from the labels scanned will be entered into the wireless scanning device and subsequently transmitted to the server, either at a user defined time, server specified time, device specified time, or in real time. The server will receive the participant data given upon user registration and the data from the participant's scanned labels. The server may compile a list of matches between participants, such as vendors and consumers, and transmit or otherwise deliver the matching data, alert, or other suitable message to the relevant participants, for example, to an exhibitor terminal, wireless device, cell phone, etc. In some embodiments the server may send the relevant message or communications to a consumer, or to other selected parties. In some embodiments the server may substantially instantaneously (i.e. in real time) transmit matching data or other selected data or alerts etc. to an exhibitor or vendor, so that the exhibitor or vendor may be able to identify a prospective consumer while the consumer is at or near the booth or station of the exhibitor. In other embodiments the server may compile and/or store matching data or other selected data or alerts etc., and transmit or otherwise transfer the relevant data to one or more participants, such as exhibitors, consumers or other selected parties, upon request.

According to some embodiments the consumer data entered by a consumer upon registration may be utilized in accordance with variable server settings and exhibitor requirements. For example, an exhibitor may determine that they only want the server to make a real time match if an interested consumer, herein referred to as a “preferred” user, is from, for example, a selected region or location, a selected age range, a defined type of business (e.g., OEM, distributor, retail chain), or from a selected company size etc. In other examples a preferred user may be defined according to product or services of interest, volume or cost of products or services required, etc. In this way, and exhibitor may define one or more definitions, criteria and/or rules for preferred matches, and the system will operate to identify and connect the exhibitor with such preferred clients according to the exhibitor preferences. Of course, other structures, elements, criteria and rules may be used.

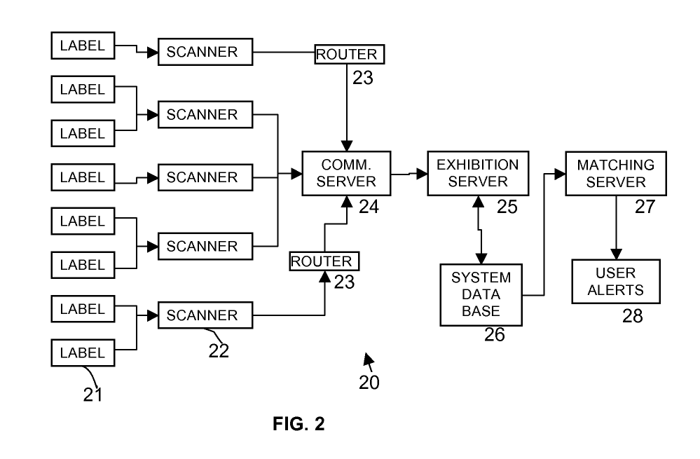

Reference is now made to FIG. 2 which is a schematic block diagram illustration of a system for enabling automated matching of participants, such as potential sellers and buyers, according to some embodiments. As can be seen in FIG. 2, the system 20 may include multiple encoded labels or tags 21, which may be scanned by multiple scanner devices 22. Data from scanner devices 22 may be transmitted, for example via a radio network, and optionally via routers 23, to communications server 24. Communications server 24 is in communication with Exhibition server 25, which may incorporate software, programs, applications, code or business logic for handling, processing and filtering system data provided by system data base 26. System data base 26 may include scanned data from labels 21, and data from scanner devices 22, thereby including user data, user identity, registration data, product data, object data media data, booth data, supplier data, and other relevant exhibition data, system data etc. For example, the system database 26 may include varied user data, exhibition management data, exhibitor data, user behavior data, demographic data, payment data, purchasing data, facility usage data, historical data etc., from the user registration, supplier registration, booth activity, user activity etc.

System database 26 may be in communication with a Matching server 27, which includes software, programs, applications, code or business logic for enabling automated matching of participants, such as buyers and sellers or vendors and consumers, on the basis of the system data. For example, matching server 27 may be capable to collect, track, analyze, enrich and filter data from System database 26, thereby generating timely or even real time or substantially real time data and/or alerts 28 relating to matched participants. In one example, Matching server 27 may determine, for example that a particular seller and a particular buyer are well matched in terms of interests, positions, status and/or needs etc. Further, the Matching server 27 may determine the respective geographical positions of the buyer and seller. In this sample case, when the buyer and seller come within a selected proximity or distance from each other, the matching server may generate an alert, signal or message to the buyer and/or seller suggesting that the other part is in the vicinity, to encourage a meeting between the respective participants.

In a further example, the Matching server is capable to match a first participant's needs with a second participant's wears (e.g., products or services for offer) based on the first participant's profile, for example, budget range, demographic profile, areas of interest, job position, place of employment etc.

In another example, the Matching server is capable to match a first participant's needs with a second participant's wears based on the first participant's behavior, for example, based on an analysis of where the participant has visited, spent time, what they have eaten, who they have met with etc.

In an additional example, the Matching server is capable to match a first participant's needs with a second participant's wears based on the first participant's scanning activity, for example, based on an analysis of which booths, services, people, objects or products they have scanned.

According to some embodiments, alerts or messages may be filtered, coded or otherwise managed by the Matching server 27, based on selected criteria. For example, closest matches may be given higher priority and may be listed higher, scored higher, color coded or otherwise differentiated from lower priority alerts. In one example, the Matching server may store a list of matches or potential matches for a participant, and may send alerts or messages to the participant relating to the matches, in accordance with selected rules. For example, the participant may initially define 5 areas of interest, and rank them in order of importance. In such a case, if similar strength matches would be generated got each of the five areas of interest, the matches may ranked in order of importance based on the order of importance defined by the participant upon registration. In another example, a variety of matches may be listed for a participant, and only when the participant is within a selected proximity from another matched participant, the relevant match alert will be sent to the participant(s). Of course, multiple matches may be handled, and the matches may be managed using filtering, coding, ranking, scoring etc.

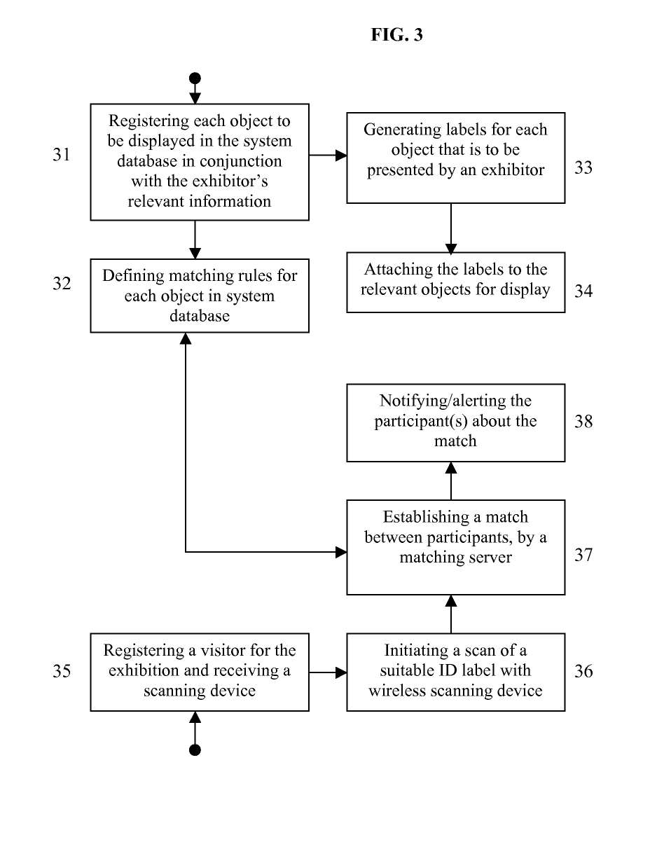

FIG. 3 schematically illustrates a series of operations or processes that may be implemented to enable automated matching of potential sellers and buyers, according to some embodiments. As can be seen in FIG. 3, at block 31, before an exhibition starts, an exhibitor may register in the system database each product or item to be displayed, in conjunction with the exhibitor's relevant information. Additionally, at block 32, the exhibitor may define matching rules or criteria for each object or label, for example, that define the preferred participant, such a consumer on investor, for the object represented by the label. For example, the exhibitor may define preferred visitors according to parameters that are defined by the system (e.g. country, company category, company size, company name, title etc). Other criteria, rules, definitions etc. may be used. At block 33 the system generates labels (optionally unique labels) for each product or item that is to be presented by an exhibitor. At block 34, the exhibitor attaches the labels to the relevant items for promotion or display. At block 35, a participant, consumer, visitor or user of the system registers for the exhibition, including entering relevant user data as required by the system (e.g. country, company category, company size, company name, title etc), and receiving a scanning device associated with the participant's user data. User data may include specifically defined matching data. Other criteria, rules, definitions etc. may be used. At block 36, when a registered visitor visits a booth or lecture etc. of interest, the user may initiate a scan of the suitable label with his/her wireless scanning device. In other embodiments the exhibition system may monitor the participant's movement or behavior, whether based on scanning history and/or based on non-scanning behavior. At block 37, the matching database, which is in communication with the system database, generates and/or verifies a match between the visitor data and the criteria set by the exhibitor. At block 38, if the visitor data matches the exhibitor criteria, then the system may notify or alert the exhibitor and/or the visitor that the match has been made, or that the scanning event occurred. For example, the server may send an SMS to a predefined cellular number of the exhibitor, with the visitor details, or send a MMS, Instant Message, Email, or a message using other messaging means, to a predefined cellular number of the exhibitor, with the visitor details, optionally including a picture. Alternatively, the server may send an email a message to a predefined mail of the exhibitor, or enable a pop-up message on the exhibitor's PC or communications device with all the relevant details. In other embodiments a pre defined message may be transmitted to the visitors scanner device (if the scanner has a display), or a buzzer or led or other alert may be triggered. In yet other embodiments an SMS, MMS, email or a message using other messaging means may be sent to the visitor's pre defined cellular phone or PC with the relevant exhibitor details. In other embodiments the alerts may be compiled and sent to the user and/or the exhibitors at a selected time interval, or after the exhibition is finished. Any combination of the above steps may be implemented. Further, other steps or series of steps may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1-15. (canceled)

16. A system for enabling automated participant matching at an exhibition, comprising:
multiple scan-able labels for multiple objects in an exhibition;
scanning devices adapted to scan data from said labels;
a communications server for enabling collection and communication of scanned data, said communications server being coupled to an exhibition server being in communication with a system database, said exhibition server being adapted to manage data processing for multiple registered users at an exhibition; and
a matching server adapted to run code to generate matches between exhibition participants.

17. The system of claim 16, wherein said matching server is adapted to deliver matching related messages to selected exhibition participants.

18. The system of claim 16, wherein said matching server includes business logic for enabling automated matching of said participants, based on data from said system database.

19. The system of claim 18, wherein said matching server includes business logic for enabling automated matching of said participants, based on participant behavior.

20. The system of claim 16, wherein said matching server is capable to implement one or more processing actions selected from the group consisting of collecting, tracking, analyzing, enriching, executing and filtering data from said system database.

21. The system of claim 16, wherein said matching server is capable to generate substantially real time matching related messages for one or more matched participants.

22. The system of claim 16, wherein said matching server is capable to determine a match between a first participant and a second participant, and to send an alert to said first participant when said first participant comes within a selected proximity of said second participant.

23. The system of claim 16, wherein said matching server is capable to match a first participants needs with a second participant's offering based on said first participant's profile.

24. The system of claim 16, wherein said matching server is capable to match a first participant's needs with a second participant's offering based on said first participant's behavior.

25. The system of claim 16, wherein said matching server is capable to match a first participant's needs with a second participant's offering based on said first participant's scanning activity and profile.

26. A method for enabling automated participant matching at an exhibition, comprising:
registering in the exhibition's system database each object to be displayed, in conjunction with an exhibitor's relevant information;
defining matching rules for each label;
generating a label for each object that is to be presented by said exhibitor;
attaching said label to each object being presented;
registering a participant with exhibition's system database, and entering relevant participant data and giving the participant a scanning device associated with said participant's user data; and
executing code to automatically generate a match between said exhibitor and said participant.

27. The method of claim 26, comprising transmitting a message relating to said match to said exhibitor.

28. The method of claim 26, comprising transmitting a message relating to said match to said participant.

29. The method of claim 26, comprising transmitting a message relating to said match to one or more users, substantially in real time.

30. The method of claim 26, comprising managing multiple matching data for exhibition participants.

31. A matching server for automatically matching users at an exhibition, comprising:
running executable code for matching system users, said users being registered in an exhibition database,
wherein said users being matched are connected via the scanning by a first user of an ID label, using a scanning device.

32. The server of claim 31, wherein said ID label is associated with an object.

33. The server of claim 31, comprising running executable code to generate match related messages to be sent to a system user.

34. The server of claim 31, comprising communicating with an exhibition server, to generate user matches in accordance with user behavior during an exhibition.

35. The server of claim 33, wherein messages relating to generated user matches are delivered following an exhibition.
